(19) United States
(12) Patent Application Publication
(10) Pub. No.: US 2025/0294114 A1
(43) Pub. Date: Sep. 18, 2025

(54) ENHANCEMENT OF DISRUPTED VIDEO STREAMS

(71) Applicant: Microsoft Technology Licensing, LLC, Redmond, WA (US)

(72) Inventor: Ryen William WHITE, Woodinville, WA (US)

(73) Assignee: Microsoft Technology Licensing, LLC, Redmond, WA (US)

(21) Appl. No.: 18/606,531

(22) Filed: Mar. 15, 2024

(51) Int. Cl. H04N 5/265; G06T 11/00; G06V 10/26; G06V 20/40; G06V 40/16; G06V 40/20; G11B 27/036

(52) U.S. Cl. CPC H04N 5/265; G06T 11/00; G06V 10/26; G06V 20/41; G06V 20/48; G06V 40/174; G06V 40/20; G11B 27/036

(57) ABSTRACT

This document relates to enhancement of video signals. For instance, some implementations can detect a disruption to a video signal and then analyze a depiction of a user in a received frame of the video signal. Then, a determination can be made whether to replace the received frame with a replacement frame based on the depiction of the user. For instance, the received frame can be replaced when the received frame depicts the user having a particular gesture or facial expression that has been designated for replacement.

### BACKGROUND

One important use case for computing devices involves teleconferencing, where participants communicate with remote users via audio and/or video over a network. Often, audio or video signals for a given teleconference can include impairments that can be mitigated by enhancing the signals with an enhancement model, e.g., by removing noise or echoes from an audio signal or correcting low-lighting conditions in a video signal. However, while existing enhancement models can significantly improve audio and video quality, there remain further opportunities to improve user satisfaction in teleconferencing scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for selectively replacing video frames in disrupted video streams. One example includes a method or technique that can be performed on a computing device. The method or technique can include receiving a video signal. The method or technique can also include detecting a disruption to the video signal. The method or technique can also include responsive to detecting the disruption to the video signal, analyzing a depiction of a user in a received frame of the video signal. The method or technique can also include determining whether to replace the received frame based at least on the depiction of the user. The method or technique can also include in at least one instance, replacing the received frame with a replacement frame. The method or technique can also include outputting the replacement frame for display processing.

Another example entails a system comprising a processor and a storage medium storing instructions. When executed by the processor, the instructions cause the system to receive a video signal. The instructions can also cause the system to in an instance when there is a disruption to the video signal, analyze a depiction of a user in a received frame of the video signal. The instructions can also cause the system to determine whether to replace the received frame based at least on the depiction of the user. The instructions can also cause the system to in at least one instance, replace the received frame with a replacement frame. The instructions can also cause the system to output the replacement frame for display processing.

Another example includes a computer-readable storage medium storing instructions which, when executed by a computing device, cause the computing device to perform acts. The acts can include receiving a video signal. The acts can also include detecting a disruption to the video signal. The acts can also include responsive to detecting the disruption to the video signal, analyzing a depiction of a user in a received frame of the video signal. The acts can also include determining whether to replace the received frame based at least on the depiction of the user. The acts can also include in at least one instance, replacing the received frame with a replacement frame.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1A illustrates an example of a generative image model that can be employed for generating video frames, consistent with some implementations of the present concepts.

FIG. 1B illustrates an example of an image classification model that can be employed for classifying gestures and/or facial expressions in images such as video frames, consistent with some implementations of the present concepts.

FIG. 2 illustrates an example workflow for selectively replacing video frames in disrupted video streams, consistent with some implementations of the present concepts.

FIGS. 3A, 3B, and 3C illustrate example timelines for video frame replacement based on a detected gesture, consistent with some implementations of the disclosed techniques.

FIGS. 4A, 4B, and 4C illustrate example timelines for video frame replacement based on a detected facial expression, consistent with some implementations of the disclosed techniques.

FIG. 5 illustrates an example system, consistent with some implementations of the present concepts.

FIG. 6 illustrates an example method or technique for selectively replacing video frames in disrupted video streams, consistent with some implementations of the disclosed techniques.

### DETAILED DESCRIPTION

### Overview

As noted above, audio or video signals for a teleconference can be enhanced using a wide range of techniques. For instance, video signals can be enhanced using sharpening algorithms, adjusting contrast or brightness, etc. In addition, videos can be enhanced by blurring backgrounds or providing customized backgrounds during a teleconference. These enhancements can greatly improve user experiences for participants in a teleconference.

However, while these techniques can improve some aspects of video quality for teleconferences, there remain other issues that can degrade video quality. For instance, in some cases, playback of a video stream can be interrupted by network, hardware, or software issues that result in a temporary “freezing” of playback. In some cases, this is relatively innocuous, as the “frozen” frame is relatively natural and is not perceived as unusual or out of place by other participants in the teleconference.

However, there are times when a frozen video frame can depict a user in a manner that can be distracting to other call participants and/or embarrassing for the user depicted in the frozen video frame. For instance, users may make many momentary facial expressions or gestures during a call that are not necessarily problematic if the video call is not disrupted. However, if the video stream happens to freeze just as the user is making a particular facial expression or gesture, then the facial expression or gesture can persist for a longer period of time, thus degrading the experience for the participants in the call.

The disclosed implementations can overcome these deficiencies of prior teleconferencing techniques by detecting disruptions to a received video signal. When a disruption is detected, a depiction of a user in a received frame of the video signal can be analyzed. For instance, the analysis can determine whether the user is depicted in the received frame as having a particular gesture and/or facial expression that is designated for replacement. If so, then the received frame can be replaced with a replacement frame that does not have the designated gesture and/or facial expression, and the replacement frame can be output for display. Otherwise, the received frame can be output for display.

As discussed more below, in some implementations the replacement frame can be provided by a generative image model. For instance, a generative image model can be prompted to modify the received frame to remove a particular gesture and/or facial expression. In other implementations, a default background image and/or a previous image of a user can be provided in the replacement frame.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “signal” refers to a function that varies over time or space. A signal can be represented digitally using data samples, such as audio samples, video samples, or one or more pixels of an image. The term “mixing,” as used herein, refers to combining two or more signals to produce another signal. Mixing can include adding two audio signals together, interleaving individual audio signals in different time slices, adding video signals and audio signals together to create a playback signal, etc. The term “synchronizing” means aligning two or more signals, e.g., prior to mixing. For instance, two or more microphone signals can be synchronized by identifying corresponding frames in the respective signals and temporally aligning those frames. Likewise, loudspeakers can also be synchronized by identifying and temporally aligning corresponding frames in sounds played back by the loudspeakers. In addition, audio signals can be synchronized to video signals. The term “playback signal,” as used herein, refers to a signal that can be played back by a loudspeaker, a display, etc. A playback signal can be a combination of one or more microphone signals and one or more video signals.

The following discussion also mentions audio/visual devices such as microphones, loudspeakers, and video devices (e.g., web cameras). Note that an A/V device for a computing device can be an integrated component of that computing device (e.g., included in a device housing) or can be an external peripheral in wired or wireless communication with that computing device.

The term “generative model,” as used herein, refers to a machine learning model employed to generate new content. One type of generative model is a “generative image model,” which is a model that generates images or video. For instance, a generative image model can be implemented as a neural network, e.g., a generative image model such as Stable Diffusion or DALLE. A generative image model can generate new image content using inputs such as a natural language prompt and/or an input image. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, audio, application states, code, or other modalities as inputs and/or generating combinations of text, images, audio, application states, or code or other modalities as outputs. Here, the term “generative image model” encompasses multi-modal generative models where at least one mode of output includes images or video.

The term “prompt,” as used herein, refers to input provided to a generative model that the generative model uses to generate outputs. A prompt to a generative image model can include a description of one or more characteristics of an image to be produced by the generative image model. For instance, the prompt can describe objects to add or remove from an existing image, modifications to be made to an object in a given image, etc.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Generative Image Model

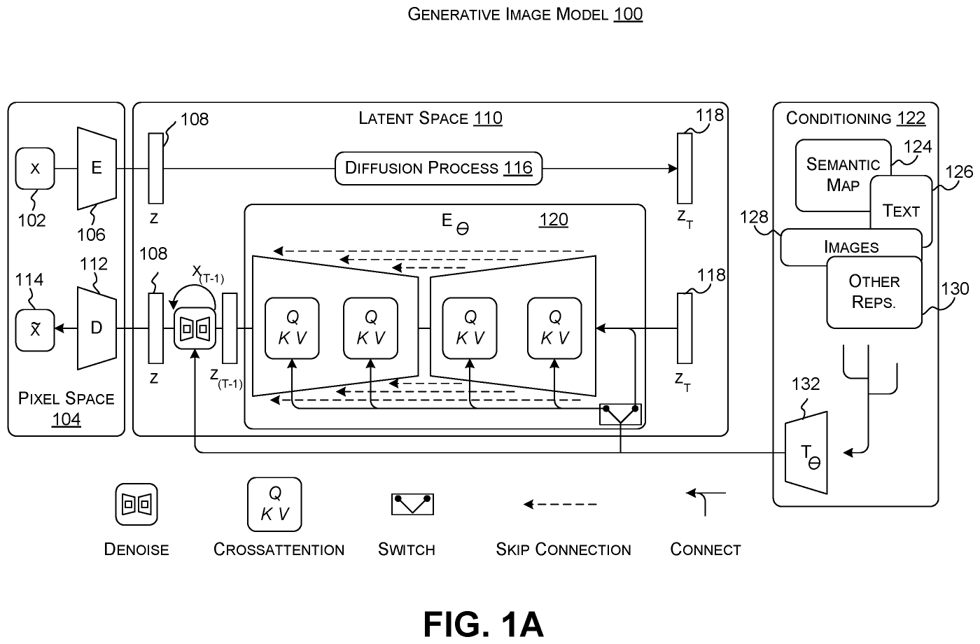

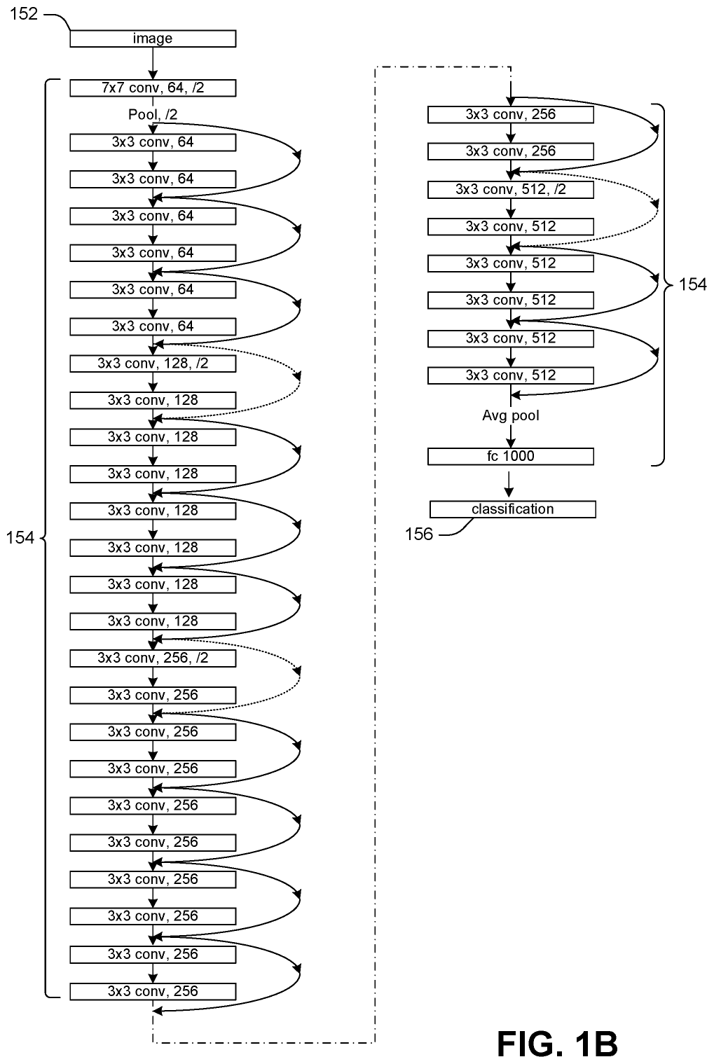

FIG. 1A illustrates an example generative image model 100. An image 102 (X) in pixel space 104 (e.g., red, green, blue) is encoded by an encoder 106 (E) into a representation 108 (Z) in a latent space 110. A decoder 112 (D) is trained to decode the latent representation Z to produce a reconstructed image 114 (X˜) in the pixel space. For instance, the encoder can be trained (with the decoder) as a variational autoencoder using a reconstruction loss term with a regularization term.

In the latent space 110, a diffusion process 116 adds noise to obtain a noisy representation 118 (Z_{T}). A denoising component 120 (E_{⊖}) is trained to predict the noise in the compressed latent image Z_{T}. The denoising component can include a series of denoising autoencoders implemented using UNet 2D convolutional layers.

The denoising can involve conditioning 122 on other modalities, such as a semantic map 124, text 126, images 128, or other representations 130 which can be processed to obtain an encoded representation 132 (T_{⊖}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 100 can be employed for text to image generation, where an image is generated from a text prompt. In other cases, generative image model 100 can be employed for image-to-image mode, where an image is generated using an input image as well as a text prompt. Generative image model 100 can also be employed for inpainting, where parts of an image are masked and remain fixed while the rest of the image is generated by the model, in some cases conditioned on a text prompt.

In some cases, generative image model 100 can be implemented as a Stable Diffusion model (Rombach, et al., “High- Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 100, cloning the model into another copy. The copy is connected to the original model with one or more zero convolutional layers which are then optimized with the parameters of the copy. For instance, the ControlNet can be trained to preserve edges, lines, boundaries, human poses, from an image, semantic segmentations, object depth, etc. The outputs of a ControlNet can be added to connections within the denoising layer. Thus, the generative image model can produce images that are conditioned not only on text, but also aspects of another image.

### Generative Modes

Generative image model 100 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In an inpainting mode, the processing is similar to the image-to-image mode, but an image mask is used to determine which parts of the image are fixed to match the input image. The rest of the image is generated in a way that it is consistent with the fixed parts of the image. Note that the term “inpainting,” as used herein, includes filling in parts of a given image as well as extending an image outward.

### Example Image Classification Model

FIG. 1B illustrates an example of an image 152 being classified by an image classification model 154 to determine an image classification 156. For instance, image classification model 154 can be a ResNet model (He, et al., “Deep Residual Learning for Image Recognition,” in Proceedings of the IEEE Conference on Computer Vision and Pattern Recognition, 2016, pp. 770-778). The image classification model can include a number of convolutional layers, most of which have 3×3 filters. Generally, given the same output feature map size, the convolutional layers have the same number of filters. If the feature map size is halved by a given convolutional layer (as shown by “/2” in FIG. 1B), then the number of filters can be doubled to preserve the time complexity across layers.

After the image has been processed using a series of convolutional layers, the image is processed in a global average pooling layer. The output of the pooling layer is processed with a 1000-way fully-connected layer with softmax. The fully-connected layer can be used to determine a classification, e.g., an object category of an object in image 102.

The respective layers within image classification model 154 can have shortcut connections which perform identity operations:

$$y = F ( x , \{ {W}_{i} \} ) + x \qquad ( 1 )$$

where x and y are the input and output vectors of the layers involved and F(x, {Wᵢ}) represents the residual mapping to be learned. In some connections the dimensions increase across layers (shown as dotted lines in FIG. 1B). In these cases, the following projection can be employed to match the dimensions via 1×1 convolutions:

$$y = F ( x , \{ {W}_{i} \} ) + {W}_{s} x \qquad ( 2 )$$

In some implementations, image classification model 154 can be pretrained on a large dataset of images, such as ImageNet. Such a general-purpose image database can provide a vast number of training examples that allow the model to learn weights that allow generalization across a range of object categories. Said another way, image classification model 154 can be pretrained in this fashion.

After pretraining, image classification model 154 can be tuned on another, smaller dataset for categories of interest. For instance, if a user is interested in the object classifications of surfboards and skateboards, then a smaller training dataset of images with surfboards and skateboards can be employed to tune the image classification model. In some implementations, one or more layers of the pretrained image classification model (e.g., the fully-connected layer) can be removed and replaced with another fully-connected layer that is initialized and tuned together with the existing pretrained layers. In other words, the parameters of the pretrained layers that are learned during pretraining can be adjusted during tuning, while the parameters of the newly-added fully-connected layer can be learned from scratch (e.g., a random initialization) during tuning.

Image classification model 154 can serve as a basis for pose estimation and/or facial expression recognition. For instance, labeled images of people in specific poses and/or with specific facial expressions can be used to tune a pretrained version of image classification model 154. In some cases, the pretrained classification model can be employed as a backbone by grafting additional layers onto the pretrained classification model prior to tuning.

### Example Workflow

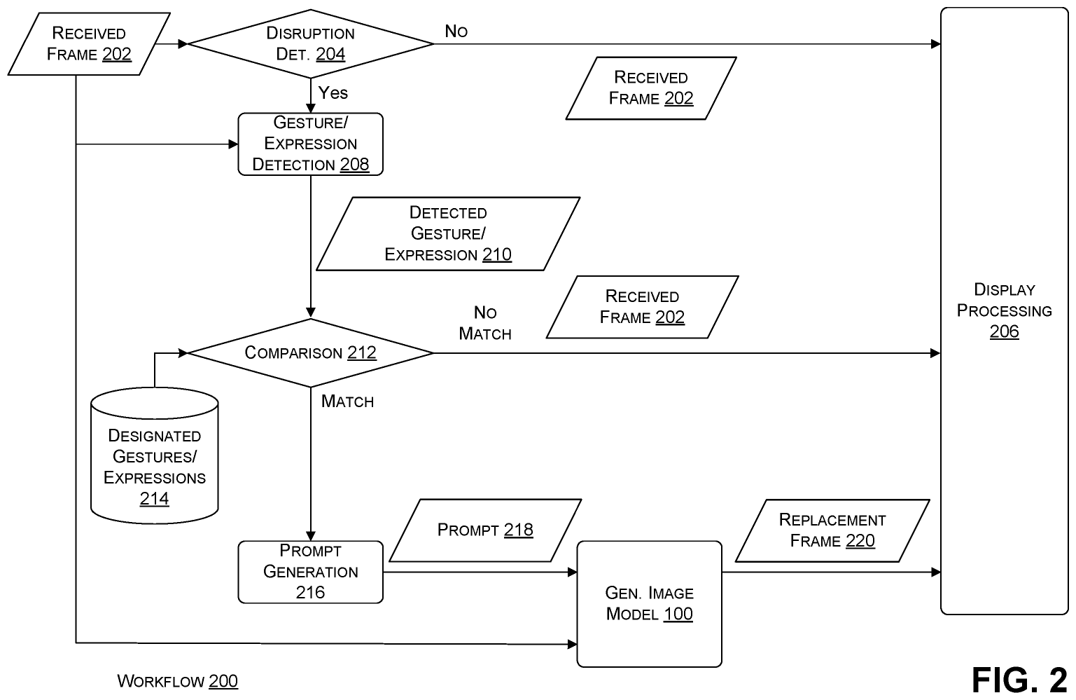

FIG. 2 illustrates an example workflow for selectively replacing video frames in disrupted video streams, such as video conferences or other streaming video applications. First, a received frame 202 is received over a network, e.g., from a client device participating in a video call. Then, disruption detection 204 is performed to determine whether the received video signal has been disrupted. As discussed more below, disruptions can be detected based on network behavior such as video packets being dropped or delayed, a reduction in the streaming rate of video, etc.

If no disruption is detected, the received frame is output to display processing 206. For instance, if workflow 200 is performed on a client device participating in a video conference, the received frame can be displayed on the client device. If workflow 200 is performed on a server device coordinating a video conference, then the received frame can be sent to participating client devices for display.

If a disruption is detected, the received frame 202 is input to gesture/expression detection 208. For instance, the received frame can be processed using a computer vision model, such as image classification model 154, to obtain a detected gesture/expression 210. A comparison 212 is performed to determine whether the detected gesture/expression matches any designated gestures/expressions 214. For instance, the designated gestures/expressions can be a predetermined set of gestures or expressions that are designated for replacement because they are deemed distracting, embarrassing, or otherwise unsuited for display during a video conference. If no match is identified between the detected gesture/expression and the designated gestures/expressions, the received frame is output to display processing 206 as described previously.

If a match is identified between the detected gesture/expression 210 and the designated gestures/expressions 214, then prompt generation 216 is employed to generate a prompt 218. The prompt and the received frame 202 are input to the generative image model 100 to generate a replacement frame 220. For instance, the prompt can instruct the generative image model to modify the received frame to remove the detected gesture/expression from the received frame, and/or can instruct the generative image model to depict the user with a neutral gesture and/or facial expression in the replacement frame. The replacement frame, instead of the received frame, is output to display processing 206 as described previously.

### Example Gesture Replacement Timelines

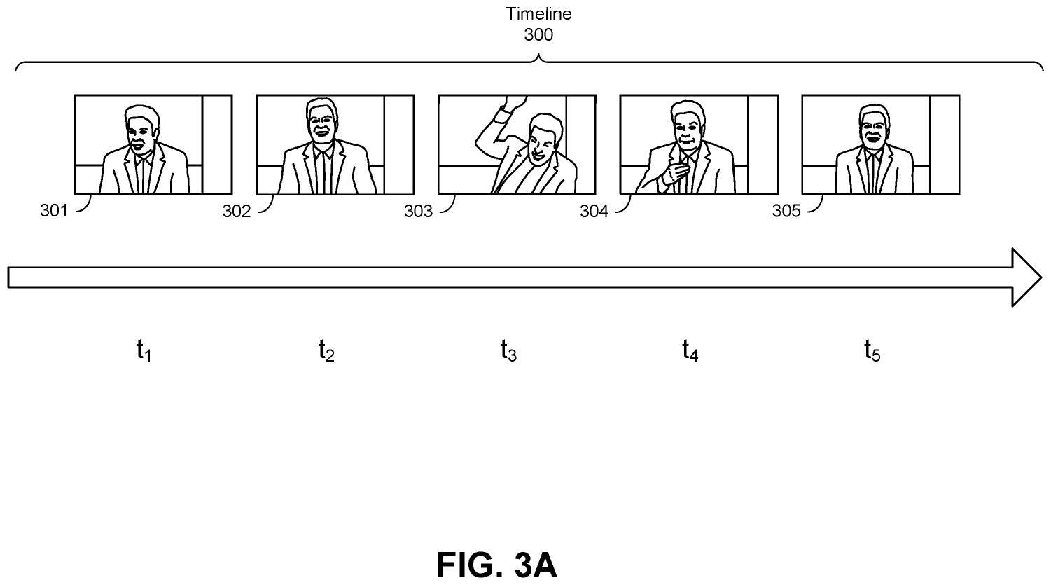

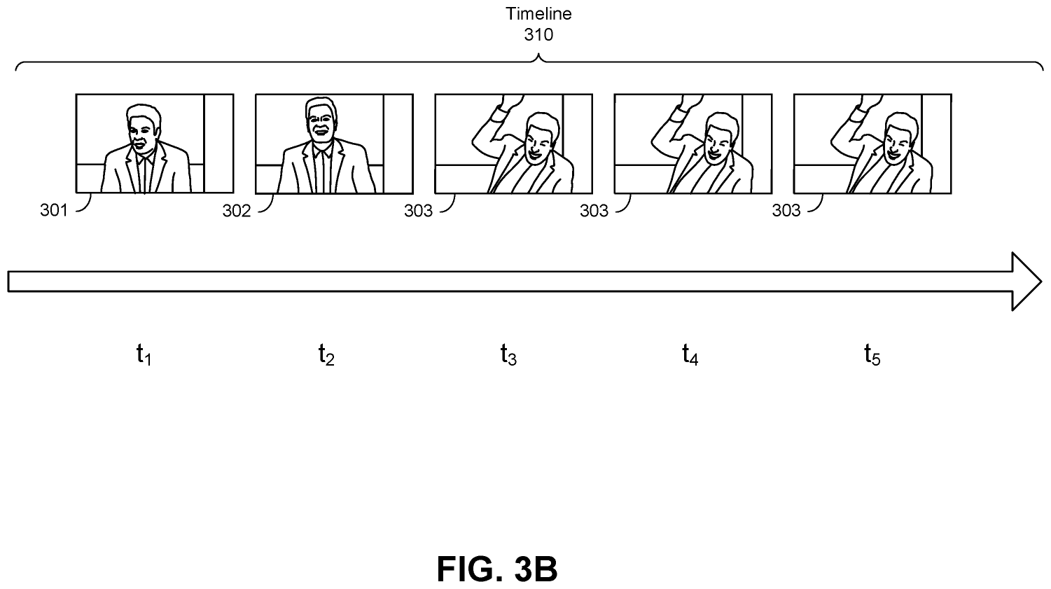

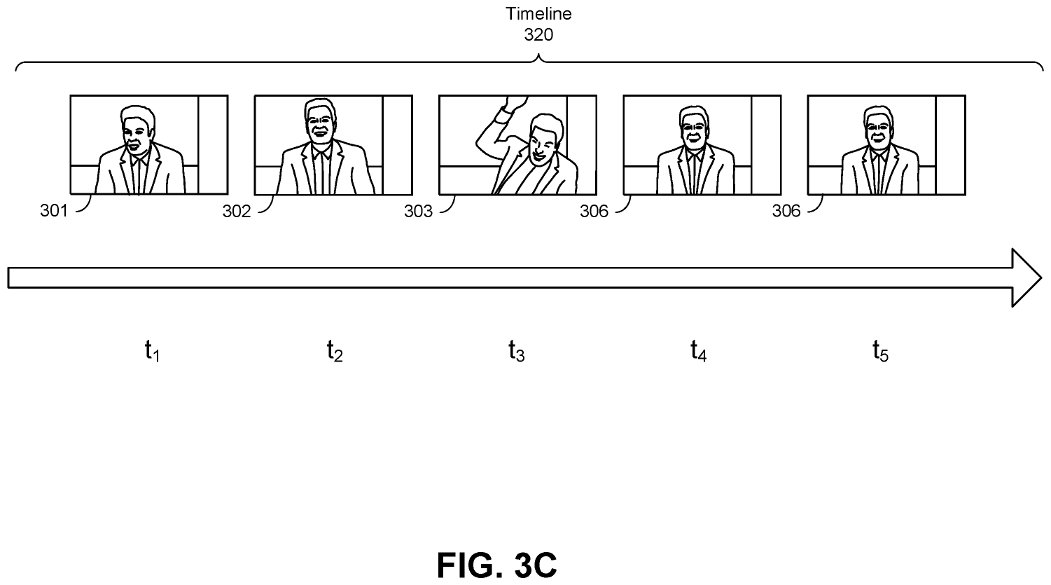

FIGS. 3A, 3B, and 3C collectively show timelines that correspond to a scenario where a user makes a gesture that is designated for replacement during a teleconference. Starting with FIG. 3A, a first example timeline 300 is shown. Timeline 300 corresponds to a scenario with an uninterrupted video stream where no disruption is detected. Frame 301 is received at time t1, frame 302 is received at time t2, frame 303 is received at time t3, frame 304 is received at time t4, and frame 305 is received at time t5. The user makes an unusual gesture at frame 303, but because the video stream is uninterrupted the gesture passes quickly and frame 303 is not replaced. Referring back to FIG. 2, timeline 300 illustrates how processing can proceed when disruption detection 204 results in no disruption being detected, e.g., the received frame is simply passed to display processing 206.

FIG. 3B shows a second example timeline 310, similar to timeline 300. However, timeline 310 corresponds to a scenario where the video stream is disrupted but no actions are taken to handle the disruption. As with the previous example, frame 301 is received at time t1, frame 302 is received at time t2, and frame 303 is received at time t3. However, for this example, assume that a disruption occurs and the video freezes at time t3. Thus, frames 304 and 305 are not received and instead frame 303 is “frozen” and remains displayed for two additional time slices. Thus, other participants in the teleconference continue to see the user making the unusual gesture for a longer period of time. This can be somewhat distracting for the other users and/or embarrassing for the user making the gesture.

FIG. 3C shows a third example timeline 320. Timeline 320 corresponds to a scenario where the video stream is interrupted but a replacement frame is substituted as described previously. As with the previous example, frame 301 is received at time t1, frame 302 is received at time t2, and frame 303 is received at time t3. A disruption is detected at time t3 and the user is depicted in frame 303 as making a gesture that is designated for replacement. Thus, a replacement frame 306 is obtained and substituted for frame 303 in time slices t4 and t5.

Replacement frame 306 can be generated by prompting a generative image model with frame 303 and instructing the generative image model to remove the gesture from frame 303, and/or to generate an image of the user with a neutral pose and expression. As another example, replacement frame 306 can be a default image of the user, and/or any previous frame of the video signal. For instance, in some implementations, image classification model 154 can be employed to classify frames of the video signal to identify a frame where the user is depicted with a neutral gesture and expression, and that frame can be employed as a replacement frame.

### Example Expression Replacement Timelines

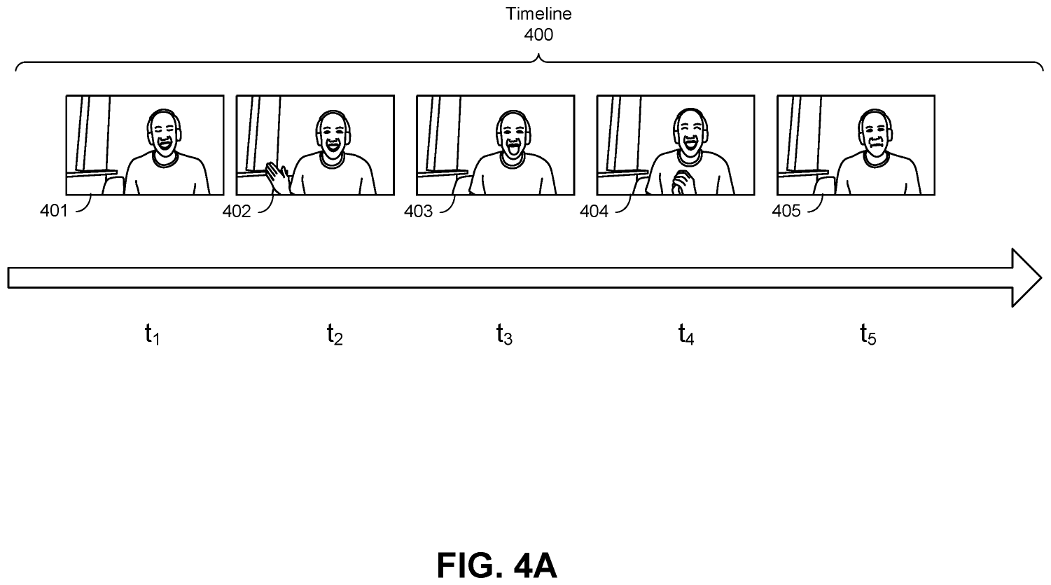

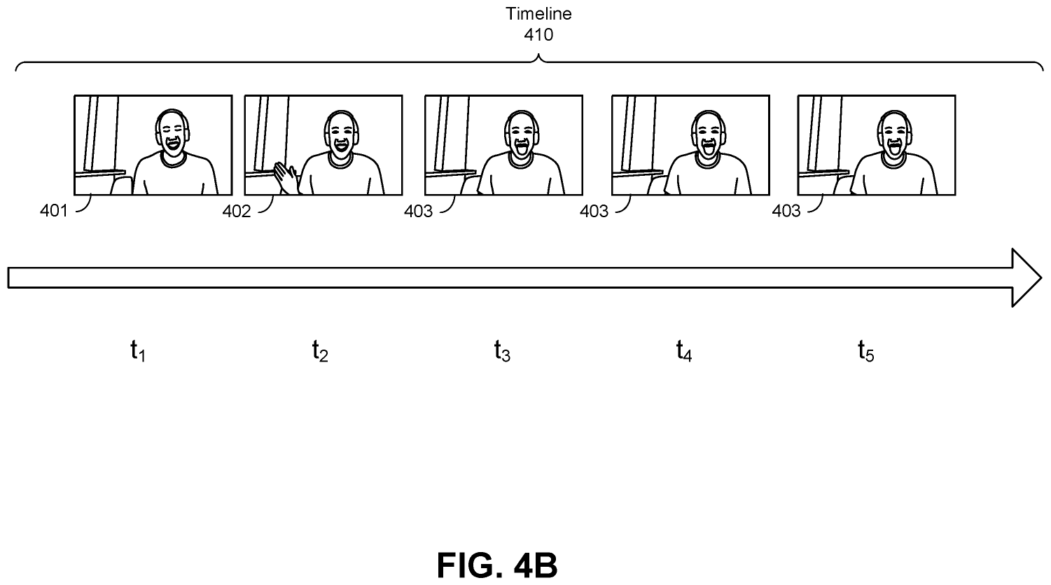

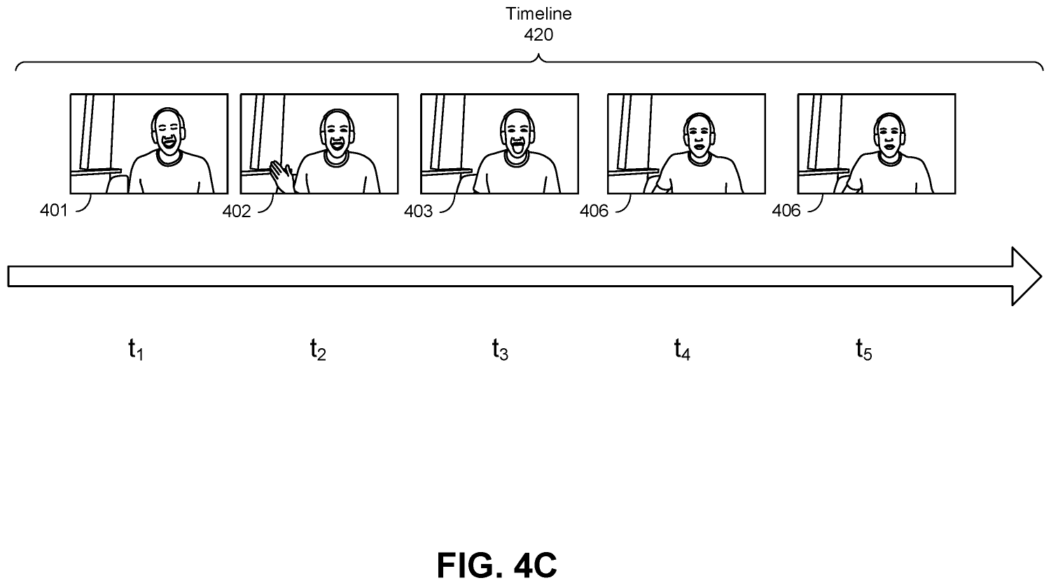

FIGS. 4A, 4B, and 4C collectively show timelines that correspond to a scenario where a user makes a facial expression that is designated for replacement during a teleconference. Starting with FIG. 4A, a first example timeline 400 is shown. Timeline 400 corresponds to a scenario with an uninterrupted video stream where no disruption is detected.

Frame 401 is the received frame at time t1, frame 402 is the received frame at time t2, frame 403 is the received frame at time t4, frame 404 is the received frame at time t4, and frame 405 is the received frame at time t5. The user makes an unusual facial expression at frame 404, but because the video stream is uninterrupted the facial expression passes quickly and frame 403 is not replaced. Referring back to FIG. 2, timeline 400 illustrates how processing can proceed when disruption detection 204 results in no disruption being detected, e.g., the received frame is simply passed to display processing 206.

FIG. 4B shows a second example timeline 410, similar to timeline 400. However, timeline 410 corresponds to a scenario where the video stream is disrupted but no actions are taken to handle the disruption. As with the previous example, frame 401 is received at time t1, frame 402 is received at time t2, and frame 403 is received at time t3. However, for this example, assume that a disruption occurs and the video freezes at time t3. Thus, frames 404 and 405 are not received and instead frame 403 is “frozen” and remains displayed for two additional time slices. Thus, other participants in the teleconference continue to see the user making the unusual facial expression for a longer period of time. This can be somewhat distracting for the other users and/or embarrassing for the user making the gesture.

FIG. 4C shows a third example timeline 420. Timeline 420 corresponds to a scenario where the video stream is interrupted but a replacement frame is substituted as described previously. As with the previous example, frame 401 is received at time t1, frame 402 is received at time t2, and frame 403 is received at time t3. A disruption is detected at time t3 and the user is depicted in frame 403 as making a facial expression that is designated for replacement. Thus, a replacement frame 406 is obtained and substituted for frame 403 in time slices t4 and t5.

Replacement frame 406 can be generated by prompting a generative image model with frame 403 and instructing the generative image model to remove the facial expression from frame 403, and/or to generate an image of the user with a neutral pose and expression. As another example, replacement frame 406 can be a default image of the user, and/or any previous frame of the video signal. For instance, in some implementations, image classification model 154 can be employed to classify frames of the video signal to identify a frame where the user is depicted with a neutral gesture and expression, and that frame can be employed as a replacement frame.

### Example System

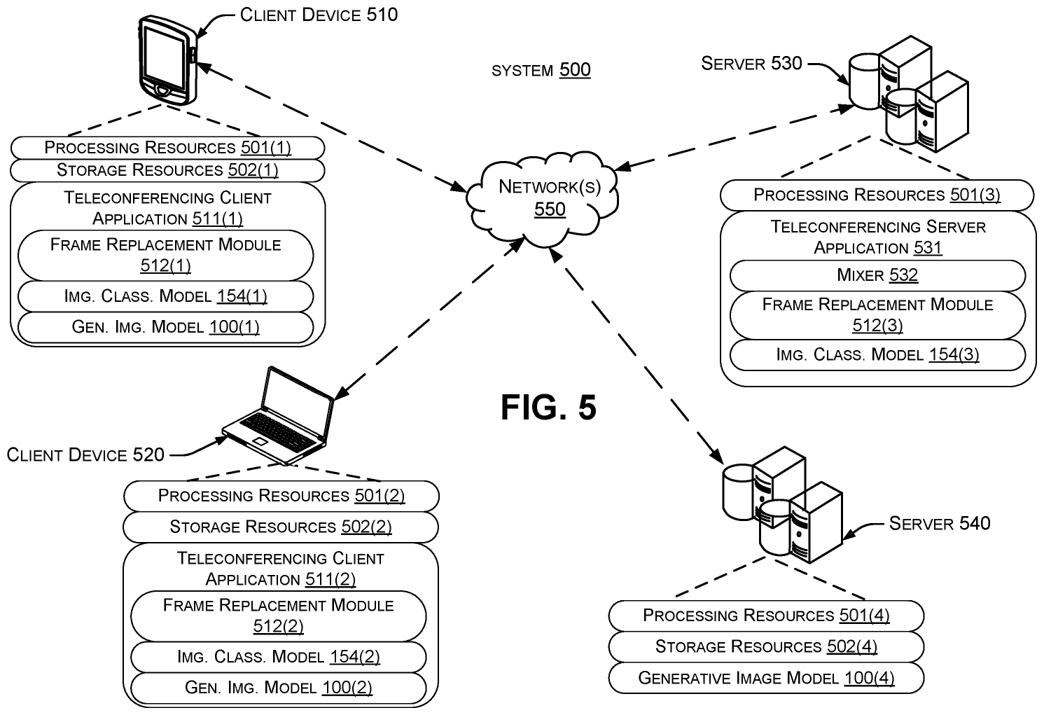

The present implementations can be performed in various scenarios on various devices. FIG. 5 shows an example system 500 in which the present implementations can be employed, as discussed more below.

As shown in FIG. 5, system 500 includes a client device 510, a client device 520, a server 530, and a server 540, connected by one or more network(s) 550. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 5, but particularly the servers, can be implemented in data centers, server farms, etc.

Certain components of the devices shown in FIG. 5 may be referred to herein by parenthetical reference numbers. For the purposes of the following description, the parenthetical (1) indicates an occurrence of a given component on client device 510, (2) indicates an occurrence of a given component on client device 520, (3) indicates an occurrence of a given component on server 530, and (4) indicates an occurrence of a given component on server 540. Unless identifying a specific instance of a given component, this document will refer generally to the components without the parenthetical.

Generally, the devices shown in FIG. 5 may have respective processing resources 501 and storage resources 502, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 510 and/or 520 can include respective instances of a teleconferencing client application 511. The teleconferencing client application can provide functionality for allowing users of the client devices to conduct audio and/or video teleconferencing with one another. For instance, the teleconferencing client application instances can buffer and play back audio and/or video received from other instances. In some cases, the teleconferencing client application instances can also perform local audio enhancement (e.g., noise reduction, echo removal, etc.) and/or video enhancement (e.g. background blurring, sharpening, contrast or brightness adjustment, etc.). The teleconferencing client application can also receive audio signals from a microphone (not shown) on each respective client device and video signals from a camera (not shown) on each respective client device. The teleconferencing client application can send the audio and/or video signals over network(s) 550 to other client devices, e.g., directly or via server 530 as discussed more below.

Client device 510 can have a frame replacement module 512(1) and client device 520 can have a frame replacement module 512(2). Each of the frame replacement modules can perform workflow 200 or the alternatives described below on frames received by the respective client devices. Client device 510 can include image classification model 154(1) and client device 520 can include image classification model 154(2), each of which can detect gestures and/or facial expressions as described previously. Client device 510 can include generative image model 100(1) and client device 520 can include generative image model 100(2), each of which can be used to generate replacement frames as described previously.

Teleconferencing server application 531 on server 530 can coordinate calls among the individual client devices by communicating with the respective instances of the teleconferencing client application 511 over network(s) 550. For instance, teleconferencing server application 531 can have a mixer 532 that selectively mixes individual microphone signals and video signals from the respective client devices to obtain one or more playback signals and communicates the playback signals to the client devices during a call.

In some cases, capabilities described above as being located on the respective client devices can be provided on one or more servers. For instance, the teleconferencing server application 531 can also have a frame replacement module 512(3) that can perform workflow 200 or the alternatives described above. Server 530 can also host image classification model 154(3) for detecting gestures and/or facial expressions. Server 540 can host a generative image model 100(4), which can be utilized for image generation by either the client devices and/or server 530.

### Example Enhancement Method

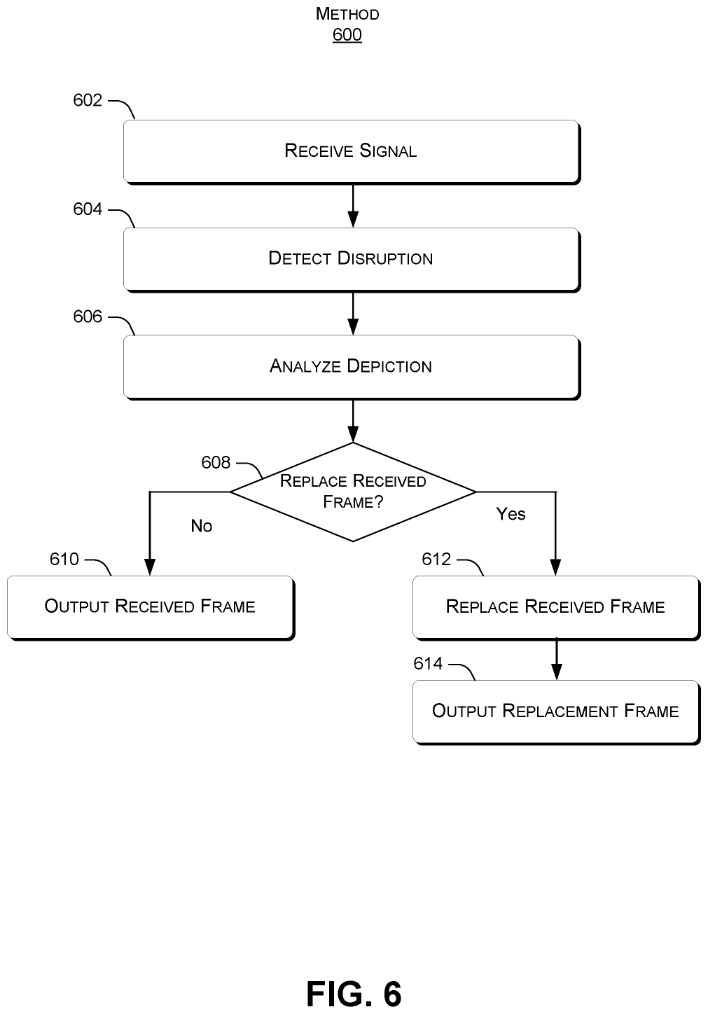

FIG. 6 illustrates an example method 600, consistent with some implementations of the present concepts. Method 600 can be implemented on many different types of devices, e.g., by one or more cloud servers, by a client device such as a laptop, tablet, or smartphone, or by combinations of one or more servers, client devices, etc.

Method 600 begins at block 602, where a video signal is received. For instance, as described previously, the received video signal can be a streaming video signal received from a client device or a server during a teleconference, a recorded video signal retrieved from storage, etc.

Method 600 continues at block 604, where a disruption to the received video signal is detected. For instance, the disruption can be detected based on network behavior such as dropped or delayed video packets, a reduction in the streaming video rate, etc. As another example, the disruption can be detected by analyzing the video signal for frozen or impaired video or audio frames.

Method 600 continues at block 606, where a depiction of a user in a received frame of the video signal is analyzed. For instance, the received video frame can be input to an image classification model to detect a gesture and/or facial expression of the depicted user. In other cases described more below, the received video frame can be analyzed by a multi-modal generative model and/or to determine an embedding representing the received frame.

Method 600 continues at decision block 608, where it is determined whether to replace the received frame. For instance, the gesture and/or facial expression detected at block 606 can be compared to a list of predetermined gestures and/or facial expressions that are designated for replacement. Alternatively, analysis of the received frame by a multi-modal generative model may indicate that the user is making an unusual gesture or facial expression that should be replaced. In other cases, a distance between an embedding representing the received frame and one or more previous frames can be compared to a threshold and the received frame can be replaced if the distance exceeds the threshold

If the received frame will not be replaced, method 600 continues at block 610, where the received frame is output for display. If method 600 is performed on a server, this can involve sending the received frame to one or more other client devices for display. If method 600 is performed on a client device, this can involve rendering the received frame locally on the client device.

If the received frame will be replaced, method 600 continues to block 612, where the received frame is replaced by a replacement frame. For instance, as noted previously, the replacement frame can be a default background image, a previously-captured image of the user, and/or generated by a generative image model. Method 600 then continues at block 614, where the replacement frame is output for display. If method 600 is performed on a server, this can involve sending the replacement frame to one or more other client devices for display. If method 600 is performed on a client device, this can involve rendering the replacement frame locally on the client device.

### Additional Implementations

There are various alternatives that can be employed for implementing the disclosed techniques. First, referring back to FIG. 2, consider disruption detection 204. One way to detect a disruption is by evaluating network packet drops and/or delays. As one example, the video streaming rate can be monitored and, if the streaming rate drops below a threshold rate, then a disruption is detected. As another example, if one or more video packets are not received within a threshold amount of time, then a disruption can be detected. In some cases, the amount of time can be specified as the size of the jitter buffer, e.g., on the order of 20-60 milliseconds. In other cases, analysis of call video and/or audio can be employed to detect disruptions.

As another example, some implementations can predict disruptions to video streams before the video streams become noticeably disrupted to the human eye. For instance, assume a video call with a frame rate of 30 frames per second, or approximately 33 milliseconds per frame. Users may not consider gestures or facial expressions distracting until they persist for a much longer period of time, e.g., 200 milliseconds. Thus, the streaming video rate can drop significantly before users are noticeably impacted by disruptions. In some implementations, a predictive (e.g., regression) model can be trained using features such as TCP, UDP, and/or Netflow statistics of network traffic to predict future video frame rates. When the model predicts that the future video frame rate will fall below a specified threshold (e.g., 15 frames per second), then a generative image model can be invoked to start generating replacement frames before users notice a degraded experience.

Once a received frame with a designated gesture/facial expression has not been updated for a threshold amount of time (e.g., 200 milliseconds), the generated replacement frames can be employed to replace the most-recently received frame. In other words, the generative image model can run in the background generating replacement frames so that they are ready in the event the video frame rate falls below the threshold. This can be particularly useful for generative image models that are remote from the device displaying the video, because this allows for adequate time to generate the replacement frames. For instance, in some implementations a client device receiving a video stream can include two separate video buffers, one having frames received from other devices participating in a teleconference and another buffer with frames received from a server-based generative image model. The client device can switch between displaying frames in the two different buffers in response to fluctuating network conditions and user gestures/facial expressions. In other implementations, a server coordinating calls can maintain a separate buffer of replacement frames for disruptions detected by the server.

In addition, note that the description of workflow 200 above matched detected expressions/gestures to a set of designated (e.g., predetermined) expressions or gestures to determine whether to replace a current video frame. However, there are various other ways to determine whether a received frame depicting a user should be replaced. For instance, the current video frame can be compared to one or more previous video frames to determine how much of an outlier the current video frame is relative to the previous video frame(s). For instance, a segmentation model can be employed to segment the user from received video frames. An image encoder can map the user segmentations to corresponding embeddings, and then the embedding(s) for the current user segmentation can be compared to an average embedding computed over multiple previous user segmentations. If the difference exceeds a threshold, then the received frame can be replaced. As another example, a multi-modal generative model could be employed to determine whether to replace a received frame. For instance, the received frame could be input to a multi-modal generative model with a prompt requesting that the multi-modal generative model evaluate the depiction of the user in the received frame. The multi-modal generative model could output an evaluation of the depiction, and that evaluation could be employed to decide whether or not to replace the received frame.

In addition, some implementations may remove unusual poses, e.g., if a user's head is at an unusual angle, then the user's pose can be corrected by instructing a generative image model to perform a correction to show the user in a neutral pose. More generally, any type of user depiction could be designated for replacement, for various reasons. For instance, one reason to replace user depictions is that the user may be making a gesture, facial expression, and/or pose that could create a negative impression when viewed by other users. In other cases, user depictions could be designated for replacement for other reasons, e.g., if one user is speaking while performing sign language, then other users could choose to subscribe to a video feed of that user where the sign language gestures are replaced with a neutral pose/gesture. In this case, there is not necessarily any negative impression associated with the sign language, but rather simply a matter of preference for other users so that they can choose whether or not sign language gestures are conveyed in a received video stream.

Furthermore, as noted previously, replacement frames are not necessarily produced using generative image models. For instance, a standard background image (e.g., a video test card) could be employed and used as a replacement image for all users. In other cases, images of users can be captured during an enrollment session where the user is instructed to make a neutral expression and pose, and the enrollment images can be used to replace current video frames. In still further cases, the beginning of a call can be treated as an implicit enrollment session, since users generally do not make unusual gestures or facial expressions during the beginning of a call.

As another example, note that the disclosed techniques can be performed to “repair” recordings of video streams. When the disclosed techniques are performed in real-time during a video call, it is likely that only the video frames preceding a frame that will be replaced are available. However, in the case of a recorded video stream being processed afterward, note that not only are the preceding video frames available but also the subsequent video frames are also available. Thus, video frames can be replaced by interpolating between preceding and subsequent video frames obtained from the recording. In some cases, this can be performed using a generative image model, e.g., by inputting one or more preceding frames and one or more subsequent frames and instructing the generative image model to generate an image representing the “missing” frame.

Furthermore, some implementations may allow different users to configure different settings for frame replacement. Some users may wish to opt out entirely, i.e., so that frames captured by their client device are not replaced irrespective of network conditions and/or how they are depicted in the frames. Other users may wish to have different settings for different types of calls. For instance, a user participating in a family call may wish to make gestures or facial expressions to make their grandchildren laugh but might wish to have those same facial expressions removed when conducting business calls. Thus, some implementations may provide different sets of designated gestures and/or facial expressions for replacement for different users, personal vs. business calls, etc.

### Technical Effect

As noted previously, video enhancement models can perform a wide range of enhancements to video signals. For instance, video enhancement models can sharpen images, improve contrast, adjust brightness, blur backgrounds, etc. However, these techniques are insufficient to deal with scenarios where users make distracting or embarrassing gestures or facial expressions during a teleconference. As noted previously, disruptions to a received video stream can result in video frames with distracting or embarrassing gestures or facial expressions persisting for a relatively long period of time (e.g., more than one second).

The disclosed techniques can overcome these deficiencies of video enhancement models by detecting disrupted video streams and selectively replacing received frames. By replacing frames with distracting or embarrassing gestures or facial expressions, improved user experiences can be provided. In addition, as noted previously, some implementations can generate replacement frames in the background using a generative image model. Then, those replacement frames can be substituted for received frames when network conditions are disrupted, and thus user gestures/facial expressions would otherwise be persistently displayed. This can overcome latency issues for remote generative image models so that the replacement frames are available immediately, without having to wait to receive them over the network when replacing a received frame.

### Device Implementations

As noted above with respect to FIG. 5, system 500 includes several devices, including a client device 510, a client device 520, a server 530, and a server 540. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 550. Without limitation, network(s) 550 can include one or more local area networks (LANs), wide area networks (WANs), the Internet, and the like.

### Additional Examples

Various examples are described above. Additional examples are described below. One example includes a method comprising receiving a video signal, detecting a disruption to the video signal, responsive to detecting the disruption to the video signal, analyzing a depiction of a user in a received frame of the video signal, determining whether to replace the received frame based at least on the depiction of the user, in at least one instance, replacing the received frame with a replacement frame, and outputting the replacement frame for display processing.

Another example can include any of the above and/or below examples where the analyzing comprises inputting the received frame to a gesture detection model and receiving a detected gesture from the gesture detection model.

Another example can include any of the above and/or below examples where determining whether to replace the received frame comprises comparing the detected gesture to one or more gestures that are designated for replacement.

Another example can include any of the above and/or below examples where the analyzing comprises inputting the received frame to a facial expression detection model and receiving a detected facial expression from the facial expression detection model.

Another example can include any of the above and/or below examples where determining whether to replace the received frame comprises comparing the detected facial expression to one or more facial expressions that are designated for replacement.

Another example can include any of the above and/or below examples where determining whether to replace the received frame comprises comparing the received frame to one or more previous frames of the video signal.

Another example can include any of the above and/or below examples where the method further comprises obtaining a first embedding representing a segmentation of the user from the received frame and a second embedding representing one or more segmentations of the user from the one or more previous frames, where the comparing is performed using the first embedding and the second embedding.

Another example can include any of the above and/or below examples where the method further comprises averaging embeddings of multiple segmentations of the user from multiple previous frames to obtain the second embedding.

Another example can include any of the above and/or below examples where the method further comprises obtaining the replacement frame from a generative image model.

Another example can include any of the above and/or below examples where the method further comprises inputting a prompt instructing the generative image model to remove a detected gesture or facial expression from the received frame.

Another example can include any of the above and/or below examples where the method further comprises inputting a prompt instructing the generative image model to depict the user with a neutral gesture, neutral pose, or neutral facial expression in the replacement frame.

Another example includes a system comprising a processor and a storage medium storing instructions which, when executed by the processor, cause the system to receive a video signal, in an instance when there is a disruption to the video signal, analyze a depiction of a user in a received frame of the video signal, determine whether to replace the received frame based at least on the depiction of the user, in at least one instance, replace the received frame with a replacement frame, and output the replacement frame for display processing.

Another example can include any of the above and/or below examples where the replacement frame comprises a predetermined background image.

Another example can include any of the above and/or below examples where the replacement frame comprises a default image of the user.

Another example can include any of the above and/or below examples where the replacement frame comprises a previous frame from the video signal.

Another example can include any of the above and/or below examples where the video signal is a recorded video signal.

Another example can include any of the above and/or below examples where the instructions, when executed by the processor, cause the system to generate the replacement frame by interpolating between at least one previous frame and at least one subsequent frame of the recorded video signal.

Another example can include any of the above and/or below examples where the interpolating is performed by generative image model.

Another example can include any of the above and/or below examples where the system further comprises detecting the disruption based at least on network latency or bandwidth of the video signal.

Another example includes a computer-readable storage medium storing instructions which, when executed by a computing device, cause the computing device to perform acts comprising receiving a video signal, detecting a disruption to the video signal, responsive to detecting the disruption to the video signal, analyzing a depiction of a user in a received frame of the video signal, determining whether to replace the received frame based at least on the depiction of the user, and in at least one instance, replacing the received frame with a replacement frame.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
receiving a video signal;
detecting a disruption to the video signal;
responsive to detecting the disruption to the video signal, analyzing a depiction of a user in a received frame of the video signal;
determining whether to replace the received frame based at least on the depiction of the user;
in at least one instance, replacing the received frame with a replacement frame; and
outputting the replacement frame for display processing.

2. The method of claim 1, wherein the analyzing comprises:
inputting the received frame to a gesture detection model; and
receiving a detected gesture from the gesture detection model.

3. The method of claim 2, wherein determining whether to replace the received frame comprises:
comparing the detected gesture to one or more gestures that are designated for replacement.

4. The method of claim 1, wherein the analyzing comprises:
inputting the received frame to a facial expression detection model; and
receiving a detected facial expression from the facial expression detection model.

5. The method of claim 4, wherein determining whether to replace the received frame comprises:
comparing the detected facial expression to one or more facial expressions that are designated for replacement.

6. The method of claim 1, wherein determining whether to replace the received frame comprises:
comparing the received frame to one or more previous frames of the video signal.

7. The method of claim 6, further comprising:
obtaining a first embedding representing a segmentation of the user from the received frame and a second embedding representing one or more segmentations of the user from the one or more previous frames,
wherein the comparing is performed using the first embedding and the second embedding.

8. The method of claim 7, further comprising averaging embeddings of multiple segmentations of the user from multiple previous frames to obtain the second embedding.

9. The method of claim 1, further comprising:
obtaining the replacement frame from a generative image model.

10. The method of claim 9, further comprising:
inputting a prompt instructing the generative image model to remove a detected gesture or facial expression from the received frame.

11. The method of claim 9, further comprising:
inputting a prompt instructing the generative image model to depict the user with a neutral gesture, neutral pose, or neutral facial expression in the replacement frame.

12. A system comprising:
a processor; and
a storage medium storing instructions which, when executed by the processor, cause the system to:
receive a video signal;
in an instance when there is a disruption to the video signal, analyze a depiction of a user in a received frame of the video signal;
determine whether to replace the received frame based at least on the depiction of the user;
in at least one instance, replace the received frame with a replacement frame; and
output the replacement frame for display processing.

13. The system of claim 12, the replacement frame comprising a predetermined background image.

14. The system of claim 12, the replacement frame comprising a default image of the user.

15. The system of claim 12, the replacement frame comprising a previous frame from the video signal.

16. The system of claim 12, the video signal being a recorded video signal.

17. The system of claim 16, wherein the instructions, when executed by the processor, cause the system to:
generate the replacement frame by interpolating between at least one previous frame and at least one subsequent frame of the recorded video signal.

18. The system of claim 17, the interpolating being performed by generative image model.

19. The system of claim 12, further comprising detecting the disruption based at least on network latency or bandwidth of the video signal.

20. A computer-readable storage medium storing instructions which, when executed by a computing device, cause the computing device to perform acts comprising:
receiving a video signal;
detecting a disruption to the video signal;
responsive to detecting the disruption to the video signal, analyzing a depiction of a user in a received frame of the video signal;
determining whether to replace the received frame based at least on the depiction of the user; and
in at least one instance, replacing the received frame with a replacement frame.
